(19) United States
(12) Patent Application Publication
(10) Pub. No.: US 2026/0163459 A1
(43) Pub. Date: Jun. 11, 2026

(54) MULTI-STAGE ELECTRIC CURRENT SINTERING METHOD FOR ENAMELED WIRES OF MOTOR STATOR AND MOTOR MANUFACTURED USING THE METHOD

(71) Applicant: THUNDER TIGER CORPORATION, Taichung City (TW)

(72) Inventor: Kwan Ju Chen, Taichung City (TW)

(21) Appl. No.: 19/331,261

(22) Filed: Sep. 17, 2025

(30) Foreign Application Priority Data
Dec. 11, 2024 (TW) 113148005

(51) Int. Cl. H02K 15/122; H02K 3/52; H02K 5/22; H02K 15/022

(52) U.S. Cl. CPC H02K 15/122; H02K 3/522; H02K 5/22; H02K 15/022

(57) ABSTRACT

A multi-stage electric current sintering method for enameled wires of a motor stator and a motor manufactured using the method are disclosed. The multi-stage electric current sintering method includes the following steps of obtaining a motor stator and applying a first current to the motor stator for a first duration, enabling a coil to generate heat so that a bonding layer of at least one enameled wire melts and is in a molten state; applying a second current to the motor stator for a second duration after the first duration ends, wherein the coil gradually cools down so that the molten bonding layer gradually solidifies; turning off the second current after the second duration ends, allowing the bonding layer to cool fully so that the enameled wire wound into the coil is secured in place on the motor stator.

### FIELD OF THE INVENTION

The present invention relates to a motor, and more particularly, to a multi-stage electric current sintering method for enameled wires of a motor stator and a motor manufactured using the method.

### BACKGROUND OF THE INVENTION

The coils of a conventional motor stator are formed by winding enameled wires. When the motor is running, the coils are subjected to the Lorentz force and generate a force. If the coils are not secured, friction between the coils will occur. Over time, this may damage the insulation layer and increase the risk of short circuits and coil burnout. Therefore, in the conventional method of manufacturing motors, varnish is used as an adhesive for securing the coils.

However, this method is quite troublesome. It is necessary to drip varnish onto the motor stator or immerse the motor stator in varnish. For the inner enameled coil to be bonded and secured smoothly, the motor needs to be preheated or placed under vacuum, allowing varnish to fully penetrate the enameled coil. Then, the enameled coil undergoes prolonged baking or exposure to sunlight to achieve final curing and shaping. This method is time-consuming and cannot meet the needs of modern industries that need to quickly manufacture small motors such as those for drones. After curing, the outer surface of the varnish tends to form uneven protrusions, which pose a risk of contact with the rotor and may affect the normal operation of the motor. In addition, varnish will pollute the production environment and emit a foul odor. If its vapor concentration reaches a certain level in an enclosed space, it poses a high risk of spontaneous combustion and presents significant safety hazards.

### SUMMARY OF THE INVENTION

The primary object of the present invention is to provide a multi-stage electric current sintering method for enameled wires of a motor stator. By applying different electric currents, a coil generates heat due to resistance to melt a bonding layer of an enameled wire. Through gradual cooling, the molten bonding layer gradually solidifies, thereby securing the coil in place on the motor stator. The process is simple and time-saving, achieving safe and rapid production of motor stators.

Another object of the present invention is to provide a motor manufactured using the foregoing method. The motor is stable in operation and has a long service life.

In order to achieve the first object, the present invention provides a multi-stage electric current sintering method for enameled wires of a motor stator, comprising the following steps of:
obtaining a motor stator and applying a first current to the motor stator for a first duration, enabling a coil to generate heat so that a bonding layer of at least one enameled wire melts and is in a molten state;
applying a second current to the motor stator for a second duration after the first duration ends, wherein the current value of the second current is lower than that of the first current, so the coil gradually cools down due to the decrease of heat generated by the coil, and the molten bonding layer gradually solidifies;
turning off the second current after the second duration ends, allowing the bonding layer to cool fully so that the enameled wire wound into the coil is secured in place on the motor stator.

In order to achieve the second object, the present invention provides a motor manufactured using the foregoing method. The motor comprises a motor housing and a motor stator manufactured using the multi-stage electric current sintering method.

### BRIEF DESCRIPTION OF THE DRAWINGS

FIG. 1 is a flow diagram showing a multi-stage electric current sintering method for enameled wires of a motor stator of the present invention;

FIG. 2 is a perspective view of the motor stator of the present invention;

FIG. 3 is another perspective view of the motor stator of the present invention, illustrating winding portions of the motor stator;

FIG. 4 is a perspective view of a motor of the present invention; and

FIG. 5 is an exploded view of the motor of the present invention.

### DETAILED DESCRIPTION OF THE PREFERRED EMBODIMENTS

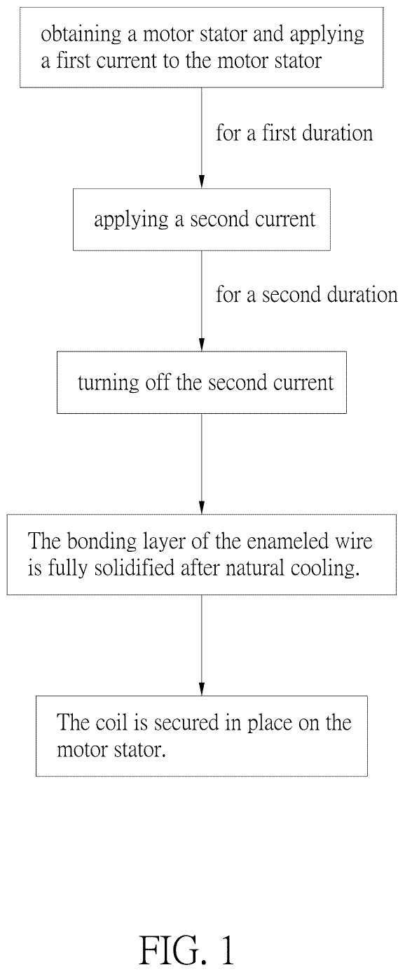

As shown in FIG. 1, a multi-stage electric current sintering method for enameled wires of a motor stator according to a preferred embodiment of the present invention comprises the following steps of:

Step 1: obtaining a motor stator and applying a multi-stage current to the motor stator. In this embodiment, a two-stage current is applied. First, a first current is applied to the motor stator for a first duration, which enables a coil to generate heat due to impedance, such that a bonding layer of an enameled wire melts and is in a molten state.

Step 2: applying a second current to the motor stator for a second duration after the first duration ends. The current value of the second current is lower than that of the first current, so the coil gradually cools down due to the decrease of heat generated by the coil due to impedance, and the molten bonding layer gradually solidifies.

Step 3: turning off the second current after the second duration ends, allowing the bonding layer to cool fully. This enables the enameled wire wound into the coil to be secured in place on the motor stator.

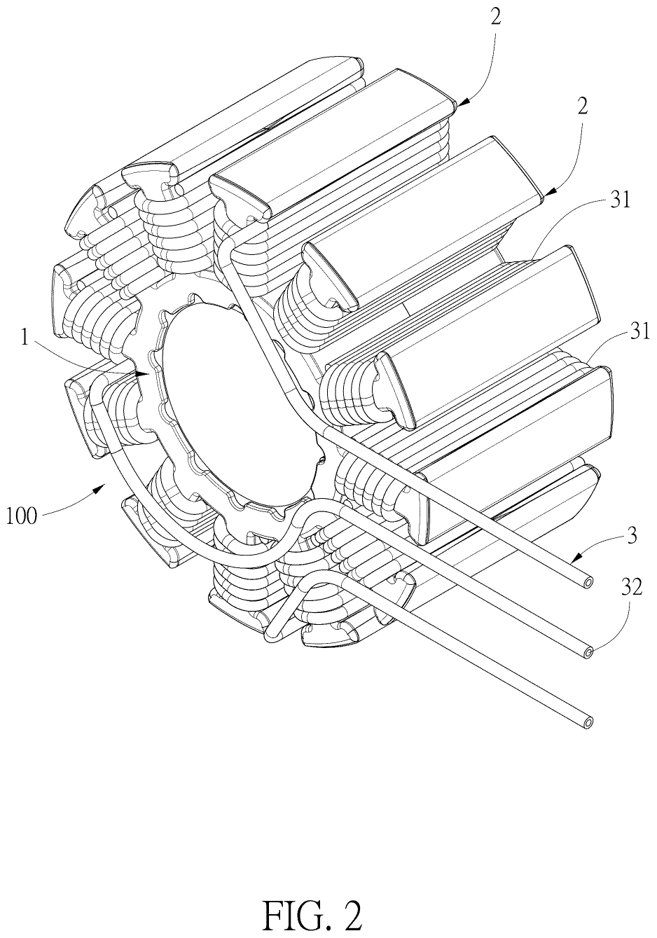

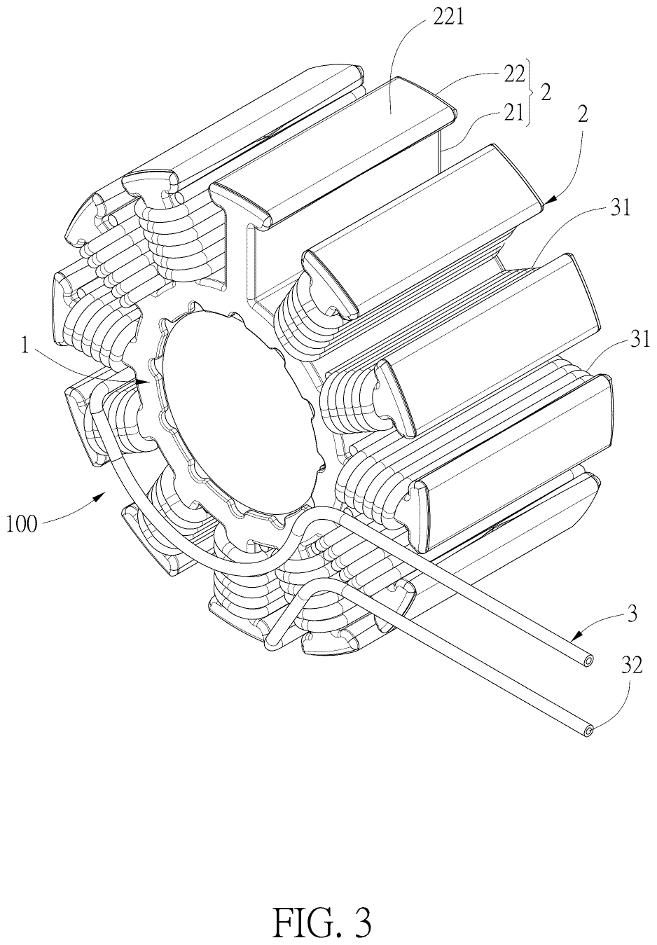

As shown in FIG. 2 and FIG. 3, a motor stator 100 has a core tube 1 that is a hollow tube and a plurality of winding portions 2 that are arranged at equal intervals around the circumferential wall of the core tube 1. In this embodiment, twelve winding portions 2 are arranged at equal intervals around the outer circumferential wall of the core tube 1. The winding portions may be arranged at equal intervals around the inner circumferential wall of the core tube 1. Each winding portion 2 has a support rib 21 and a support plate 22. Preferably, the support plate 22 is made of silicon steel. The support rib 21 has one end connected to the core tube 1 and another end connected to the support plate 22 so that the winding portion 2 is in a T shape. One side of the support plate 22, opposite to the support rib 21, is a curved surface 221. The curved surfaces 221 of the support plates 22 of the winding portions 2 together form an imaginary outer annular surface. Each winding portion 2 is wound with an enameled wire 3 around the outer periphery of the support rib 21, forming a coil 31 between the core tube 1 and the support plate 22. A bonding layer 32 is provided on the outer periphery of the enameled wire 3.

Further, according to the characteristic that the resistance value of the metal conductor in the enameled wire 3 increases proportionally with the increase of temperature, the resistance value of the metal conductor after the temperature rise can be calculated according to the melting point temperature of the bonding layer according to the following formula (1).

$${R}_{2} = \frac{( {T}_{0} + {T}_{2} ) \times {R}_{1}}{{T}_{0} + {T}_{1}} \qquad formula ( 1 )$$

where, T₀ is the temperature at which the resistance of the metal conductor is zero, measured in ° C.; T₁ is the temperature of the metal conductor before the temperature rise, measured in ° C.; T₂ is the temperature of the metal conductor after the temperature rise, measured in ° C.; R₁ is the resistance of the metal conductor before the temperature rise, measured in Ω; and R₂ is the resistance of the metal conductor after the temperature rise, measured in Ω.

Within the voltage tolerance range of the enameled wire 3, the current value of the first current is calculated based on the resistance of the metal conductor after the temperature rise according to the Ohm's law. When the current is applied, the first duration of the first current is shorter than the second duration of the second current. Since the current value of the first current is greater than the current value of the second current, the metal conductor of the enameled wire can be quickly heated to the melting point of the bonding layer, so that the bonding layer is activated by heat and is in a molten state, shortening the activation time of the bonding layer. If a large current is continuously applied for a long time, the temperature of the enameled wire 3 will be too high, damaging the bonding layer and affecting the sintering effect. This may result in the exposed metal conductor coming into contact, leading to power outages or even short circuits.

Furthermore, the current value of the applied second current gradually decreases during the second duration. By reducing the current value, the heat generated by the coil's impedance decreases, allowing the coil to gradually cool down. The temperature gradually decreases and is maintained for a longer time, such that the molten bonding layer of the enameled wire gradually solidifies at an appropriate current level, allowing the wound enameled wire 3 of the same coil 31 to be bonded together and secured in place on motor stator 100. It is particularly noted that the present invention uses a linear reduction or a gradient reduction of the second current within the second duration according to the material of the bonding layer.

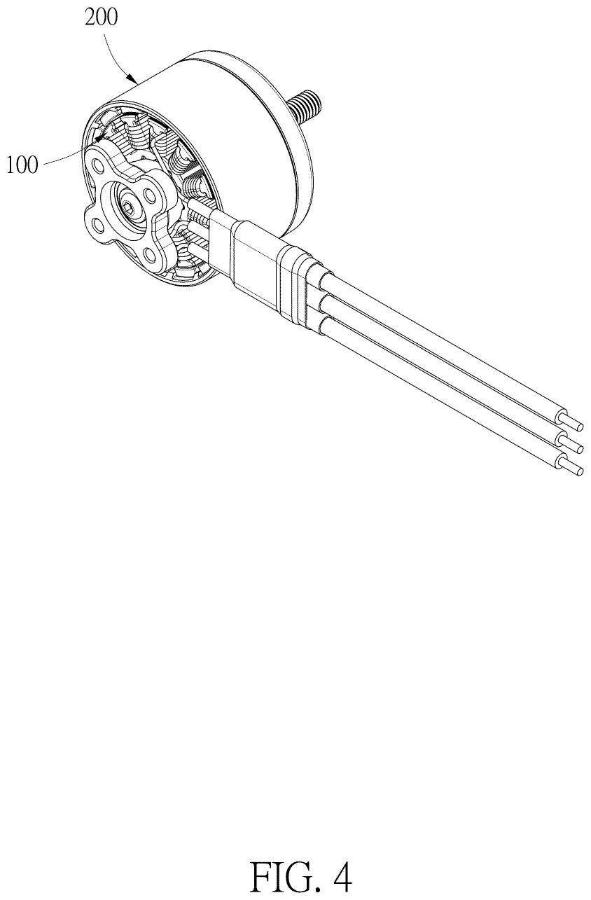

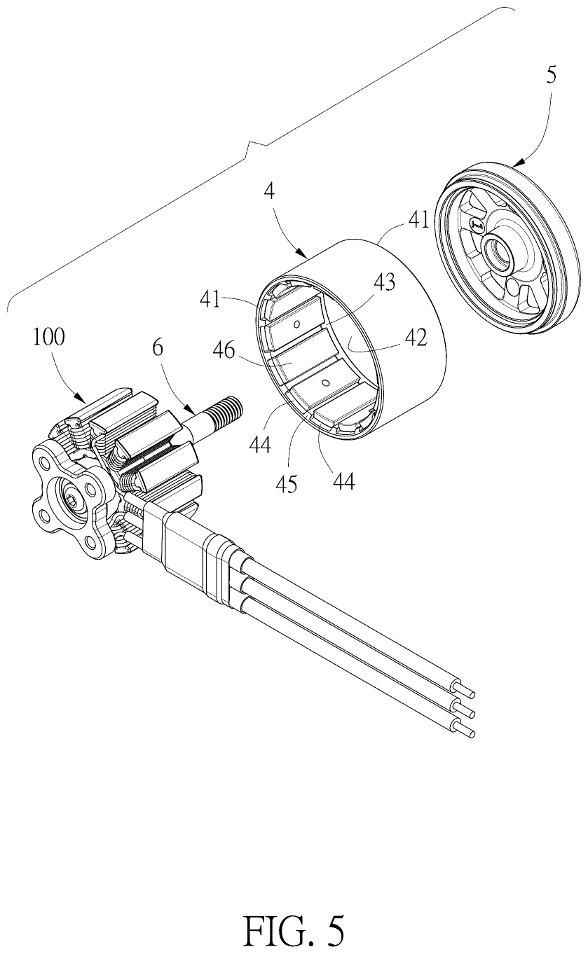

FIG. 4 and FIG. 5 illustrate a motor provided by an embodiment of the present invention, comprising a motor housing 200 and a motor stator 100 manufactured using the foregoing method.

Specifically, the motor housing 200 has a housing 4 in a cylindrical shape and an end cover 5. The housing 4 is a hollow housing extending axially and has two openings 41 at two ends thereof. The end cover 5 is coupled to one of the openings 41, forming an accommodating room 42 in the housing 4. The inner circumferential wall 43 of the housing 4 is formed with a plurality of engaging grooves 44 that are spaced at equal intervals and extend axially. Every adjacent two of the engaging grooves 44 are separated by a raised rib 45. A plurality of magnets 46 are alternately arranged in magnetic N and S poles and magnetically attracted in the respective engaging grooves 44, forming an outer rotor. The motor stator 100 is placed in the accommodating room 42. One end of a central shaft 6 is fixed to one side of the motor stator 100, and the other end of the central shaft 6 axially passes through the motor stator 100 and extends out of the end cover 5, such that the motor stator 100 is combined with the motor housing 200.

The present invention has the following technical improvements and advantages:

Firstly, the time required for securing the enameled wire is shortened, improving production efficiency. The present invention uses multi-stage current for securing the enameled wire. First, by applying the first current with a larger current value, the coil is heated up quickly to make the bonding layer of the enameled wire in a molten state. Then, the current value of the second current is gradually reduced, so the heat generated by the coil decreases and the temperature gradually drops, allowing the molten bonding layer to gradually solidify. Finally, the second current is turned off for cooling and solidifying the bonding layer of the enameled wire, thereby securing the enameled wire in place on the motor stator. The entire process can bond the enameled wire together in about 15 seconds. Compared with the conventional method of applying or dripping varnish onto the motor stator followed by oven curing for 15 to 30 minutes, this shortens the production time of the motor and improves production efficiency greatly.

Secondly, it is pollution-free and highly safe. There is no need to use varnish to assist in bonding the enameled wire, thus avoiding environmental pollution and safety issues such as the risk of spontaneous combustion caused by the use of varnish.

Thirdly, the motor production yield is improved. The surface of the sintered enameled wire is smooth. There will be no uneven bulges on the outer periphery of the enameled wire. It can avoid the uneven bulges caused by the adhesion of varnish on the surface of the support plate, ensuring that the motor runs smoothly and has a long service life, thereby improving the motor production yield.

Fourthly, it is conducive to production line integration and reduces labor costs. This method uses multi-stage current to heat the coil rapidly, enabling the bonding layer of the enameled wire to be in a molten state. The current is then reduced to cool the coil, allowing the enameled wire to bond together. Unlike the conventional method that require repeatedly transferring the motor stator between varnish and oven, it is easier to integrate the production line, thereby reducing labor costs.

1. A multi-stage electric current sintering method for enameled wires of a motor stator, comprising the following steps of:
obtaining a motor stator, wherein the motor stator has a core tube that is a hollow tube and a plurality of winding portions that are arranged at equal intervals around a circumferential wall of the core tube, the winding portions each have a support rib and a support plate, the support rib has one end connected to the core tube and another end connected to the support plate so that the winding portions are each in a T shape, one side of the support plate, opposite to the support rib, is a curved surface, the curved surfaces of the support plates of the winding portions together form an imaginary outer annular surface, each of the winding portions is wound with at least one enameled wire around an outer periphery of the support rib, forming a coil between the core tube and the support plate, and a bonding layer is provided on an outer periphery of the enameled wire;
applying a multi-stage current to the motor stator, enabling the coil to generate heat due to impedance so that the bonding layer is heated and melted, thereby securing the enameled wire;
wherein a first current is applied to the motor stator for a first duration, which enables the coil to generate heat due to impedance so that the bonding layer of the enameled wire melts and is in a molten state;
applying a second current to the motor stator for a second duration after the first duration ends, wherein a current value of the second current is lower than that of the first current, so the coil gradually cools down due to decrease of heat generated by the coil due to impedance, and the molten bonding layer gradually solidifies;
turning off the second current after the second duration ends, allowing the bonding layer to cool fully so that the enameled wire wound into the coil is secured in place on the motor stator.

2. The multi-stage electric current sintering method as claimed in claim 1, wherein the first duration is shorter than the second duration.

3. The multi-stage electric current sintering method as claimed in claim 1, wherein the current value of the second current gradually decreases during the second duration.

4. The multi-stage electric current sintering method as claimed in claim 1, wherein the support plate is made of silicon steel.

5. A motor, comprising a motor housing and a motor stator manufactured using the multi-stage electric current sintering method as claimed in claim 1.

6. The motor as claimed in claim 5, wherein the motor housing has a housing in a cylindrical shape and an end cover, the housing is a hollow housing extending axially and has two openings at two ends thereof, the end cover is coupled to one of the openings, forming an accommodating room in the housing, an inner circumferential wall of the housing is formed with a plurality of engaging grooves that are spaced at equal intervals and extend axially, every adjacent two of the engaging grooves are separated by a raised rib, a plurality of magnets are magnetically attracted in the respective engaging grooves, forming an outer rotor, the motor stator is placed in the accommodating room, one end of a central shaft is fixed to one side of the motor stator, and another end of the central shaft axially passes through the motor stator and extends out of the end cover, such that the motor stator and the outer rotor are coupled together.

7. The motor as claimed in claim 6, wherein the magnets are alternately arranged in magnetic N and S poles.
